(19) United States
(12) Patent Application Publication
(10) Pub. No.: US 2007/0214024 A1
(43) Pub. Date: Sep. 13, 2007

(54) Airline transactions using mobile handsets

(76) Inventors: Gaurav Jain, Bangalore (IN); P. S. Kousthub, Bangalore (IN); Ashwin S, Bangalore (IN)

Correspondence Address: ASHOK TANKHA;OF COUNSEL, LIPTON, WEINBERGER & HUSICK, 36 GREENLEIGH DRIVE, SEWELL, NJ, 08080, US

(21) Appl. No.: 11/517,657

(22) Filed: Sep. 8, 2006

(30) Foreign Application Priority Data
Mar. 8, 2006 (IN) 0404/CHE/2006

(51) Int. Cl. G06Q 10/00

(52) U.S. Cl. 705/5

(57) ABSTRACT

This invention proposes a method for a subscriber to exchange information and transact with a plurality of airline companies for real time search, comparison and transaction activities over mobile networks connecting a subscriber's handset, online infrastructure of airline companies, a service delivery engine and online banking infrastructure. The invention allows a subscriber to view and choose among the menus and options on the subscriber's handset for airline related transactions. The subscriber's choice among the menus and options is communicated to the service delivery engine. A plurality of online infrastructures of airline companies is queried based on the subscriber's choice. The querying, which involves searching, collating and comparing is performed by the service delivery engine, from a plurality of online infrastructures of airline companies. The result of the query is transmitted to the subscriber's handset through the mobile network and the subscriber then chooses a transaction from the result of the query.

### BACKGROUND

This invention in general relates to conducting transactions using a mobile handset and specifically relates to conducting airline transactions using mobile handsets.

There is a market need for an airline travel transaction method and system that empowers users to use their existing mobile handsets to search, compare and transact airline related transactions.

There is a market need for an airline travel transaction method and system that is user friendly and enables users to use a plurality of types of mobile handsets and mobile networks to perform search, compare and transact airline related transactions.

### SUMMARY OF THE INVENTION

The method and system disclosed herein provides an application is built into the mobile device, for conducting airline transactions. The user does not need to open an internet browser on the mobile device. The mobile device does not need to connect to an internet server.

This invention proposes a method for a subscriber to exchange information and transact with a plurality of airline companies for real time search, comparison and transaction activities over mobile networks connecting a subscriber's handset, online infrastructure of airline companies, a service delivery engine and online banking infrastructure. The invention allows a subscriber to view and choose among the menus and options for airline related transactions presented on the subscriber's handset. The subscriber's choice among the menus and options is communicated to the service delivery engine via the mobile network. The plurality of online infrastructures of airline companies is queried based on the subscriber's choice. The querying process, which involves searching, collating and comparing, is performed by the service delivery engine from a plurality of online infrastructures of airline companies. The result of the query is sent to the subscriber's handset through the mobile network. A commercial transaction choice is made by the subscriber to avail a product or service corresponding to one of query sent results. The subscriber's chosen transaction choice is communicated to the service delivery engine via the mobile network. The chosen transaction is performed at online infrastructure of the airline after conducting a successful verification operation by the service delivery engine that is in communication with the online banking infrastructure.

This invention proposes a system for a subscriber to exchange information and transact with a plurality of airline companies for real time search, comparison and transaction activities over mobile networks. A subscriber accesses the online airline infrastructure that is in communication with the mobile network using a mobile handset. A service delivery engine for interfaces with the mobile network and online banking infrastructure. The service delivery engine comprises a user information module, subscriber interaction module, search, collate and comparison module, verification and secure transaction module and merchant information module. The user information module stores data prior to transaction. The subscriber interaction module communicates the subscriber's choice. The search, collate and comparison module interfaces with plurality of said online airline infrastructures. The verification and secure transaction module conducts verification and secure transactions on online banking infrastructure. The merchant information module stores post transaction data.

One object of the present invention is to provide a subscriber the ability to perform single or multi-parameter searches, comparisons and commercial transactions that pertain to one or more airline companies.

Another object of the invention is to provide alert services to the passenger regarding late arrival, departures, etc.

Another object of the invention is to provide a subscriber the ability to receive alerts from an online airline infrastructure based on pre-defined criteria.

Another object of the invention is to provide the subscriber the ability to regenerate lost tickets via the mobile handset.

Another object of the invention is to provide the subscriber the ability to update the online airline infrastructure with no show information.

Another object of the invention is to provide the subscriber the ability to update the online airline infrastructure with late boarding information.

Another object of the invention is to provide the subscriber the ability to perform rebooking, cancellation and transfer operations using the menu and options presented on the subscriber's handset.

Another objective of the invention to provide the subscriber with historical preference data, for example the subscriber can be provided with data in the form of ‘hints’ that gives the subscriber an idea of how previous individuals with similar search criteria chose their airline.

Another object of the invention is to provide the subscriber menus and options on their handset to review and exercise bonus miles based on the frequent flier program of the airline.

Another object of the invention is to enable the subscriber to avail special deals based on prior agreements with select airlines. For example, subscribers choosing a particular airline may be given options to access business lounges and upgrade to a higher seating class.

Another object of the invention is the subscribers can avail travel and accident insurance by conducting transactions on the mobile handset.

### BRIEF DESCRIPTION OF THE DRAWINGS:

FIG. 1 illustrates a method that enables a subscriber to exchange information and transact with a plurality of airline companies for real time search, comparison and transaction activities over mobile networks.

FIG. 2A and 2B illustrates a system that enables a subscriber to exchange information and transact with a plurality of airline companies for real time search, comparison and transaction activities over mobile networks.

FIG. 3 illustrates the main components of a system that enables a subscriber to exchange information and transact with a plurality of airline companies for real time search, comparison and transaction activities over mobile networks.

### DETAILED DESCRIPTION OF THE INVENTION

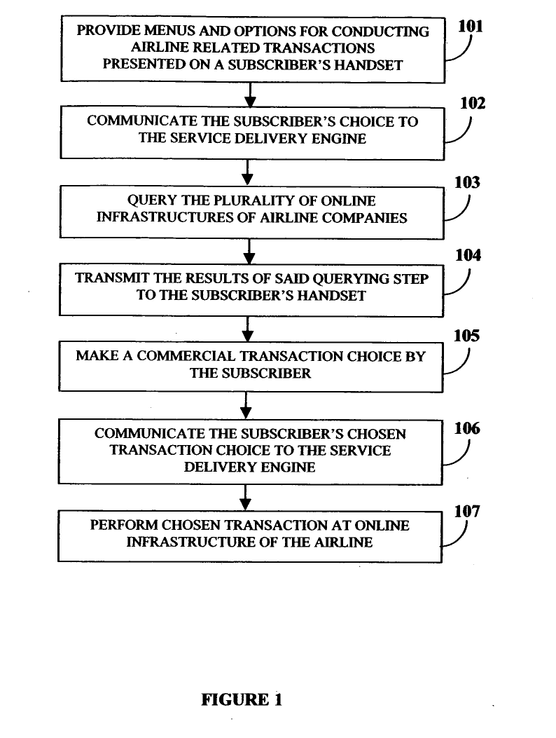

FIG. 1 illustrates a method enabling a subscriber to exchange information and transact with a plurality of airline companies for real time search, comparison and transaction activities over mobile networks. A subscriber is allowed to view and choose among the menus and options for airline related transactions presented on the subscriber's handset 101. The subscriber's choice among the menus and options is communicated to the service delivery engine via the mobile network 102. The plurality of online infrastructures of airline companies is queried based on the subscriber's choice 103. The querying is performed by the service delivery engine, which involves searching, collating and comparing from a plurality of online infrastructures of airline companies. The result of the query is sent to the subscriber's handset through the mobile network 104. A commercial transaction choice is made by the subscriber to avail a product or service corresponding to one of the sent results 105. The subscriber's chosen transaction choice is communicated to the service delivery engine via the mobile network 106. The transaction chosen by the subscriber is performed at the online infrastructure of the airline 107.

A commercial communications network offers a variety of services to the customer while being able to add or modify the portfolio of services available. This invention provides a service delivery engine that resides on designated server(s), which may be centrally located or distributed in nature, and which through interactions with the subscriber, allows the subscriber to access an array of commercial services involving interfacing and transactions with airline companies via their mobile handsets. Multiple types of handsets can be used in this invention, such as a standard cellular phone, smart phone, personal digital assistant or a satellite phone. A smart phone provides with advanced digital media features such as e-mail, messaging, web browsing, audio, video, personal information management and text/data entry. A satellite phone uses a system of earth-orbiting satellites to connect a mobile phone to the public telephone networks.

This invention is operable on a variety of mobile networks, such as Advanced Mobile Phone Service (AMPS), Code Division Multiple Access (CDMA), Global System for Mobile Communications (GSM), Digital cellular telephone system, General Packet Radio Service (GPRS) and Time Division Multiple Access (TDMA) Digital cellular telephone system.

The method of this invention is dependant on the data channels of existing networks, but is independent of any Short Messaging Service (SMS) type access method. A key aspect of the infrastructure engine is the provision for the subscribers of the communications network to select among available set(s) of services involving customized single or multi-parameter searches, comparisons and commercial transactions which pertain to one or more airline companies.

The service delivery engine queries the subscriber's online banking infrastructure to verify if a minimum required money balance exists in the subscribers account. The service delivery engine communicates with the mobile network and prompts the subscriber to enter one or more passwords. The service delivery engine uses the aforementioned passwords to securely gain access to the subscriber's account on the online banking infrastructure. The chosen transaction is performed at the online infrastructure of the airline after conducting a successful verification operation by the service delivery engine that is in communication with the online banking infrastructure.

Information on the chosen transaction is then stored in the service delivery engine. This information of the chosen transaction comprises information on fares, time of day, seat availability, flight number, flight seat number etc. The stored information is used to extract data on the average selling price of tickets, pricing patterns on specific travel segments and pricing comparison among different airlines. Monthly reports and user statistics are generated from the stored information. Airline companies use such monthly reports and user statistics for conducting customer profiling. The monthly reports and user statistics would provide information on the parameters that a user searched for, how the airline ranked in the search results, which ticket(s) the user eventually bought after performing the search, how many days before departure a user books his ticket, etc. These statistics can be grouped based under: weekdays, weekends, single ticket, two ticket, four ticket purchases, thereby enabling airline companies come up with new product promotions and pricing plans.

Alerts are sent to subscriber from the online airline infrastructure based on pre-defined criteria. Examples of alerts include: alerts from the airline to the customer on flight delays or cancellations, late or no-show notification alerts from the subscriber to the airline which then permits the subscriber to postpone or rebook the same ticket, alerts from the airline to the subscriber on boarding gate numbers, notification regarding lunch or dinner served at a lounge if the subscriber's flight is delayed, reimbursement requests sent to subscriber's companies and airline promotions.

Using the mobile handset, the subscriber has an option to regenerate lost tickets. PNR numbers are messaged to the phone, and if the user loses the PNR number, it is resent to the user on request. A copy of the boarding pass is also generated over the phone.

In case the subscriber decides not to board a flight, the subscriber using an option on the mobile handset can update the online airline infrastructure in a timely manner with “no show” information. In case the subscriber is running late for a flight, the subscriber can send a message to the online airline infrastructure on the details of their delay, for example a passenger may send a SMS message to the online airline infrastructure via the SDE that he is running half an hour late.

Corporate pre-agreed arrangements can be established between the subscriber's employer and an airline. This pre-agreed arrangement is registered at the SDE. For example, if the subscribers company has a pre-agreed arrangement with the airline operating the online airline infrastructure, the information on the user's chosen transaction is communicated by the service delivery engine to the subscribers company.

Historical preference data can be mined from the service delivery engine. The subscriber can be provided with data in the form of ‘hints’ that gives him or her an idea of how previous individuals with similar search criteria chose their airline and/or flight and/or fare. For example, the subscriber can be provided with data that a hundred people had searched for “cheapest fares”, ten people actually booked the tickets and seven of them chose “Air Deccan” airlines.

The subscriber can perform various airline related transactions using the multiple menus and options presented on the handset, including rebooking, cancellation and transfer operations.

The subscribers can perform transactions related to their frequent flier miles. They can review and exercise their bonus miles. The menu and options also includes an option to avail special deals based on prior agreements with select airlines, wherein subscribers choosing a particular airline may be given options to access business lounges and upgrade to higher seating class. The menu on the handset also provides the subscriber an option to avail other services of third party service providers, such as travel and accident insurance services.

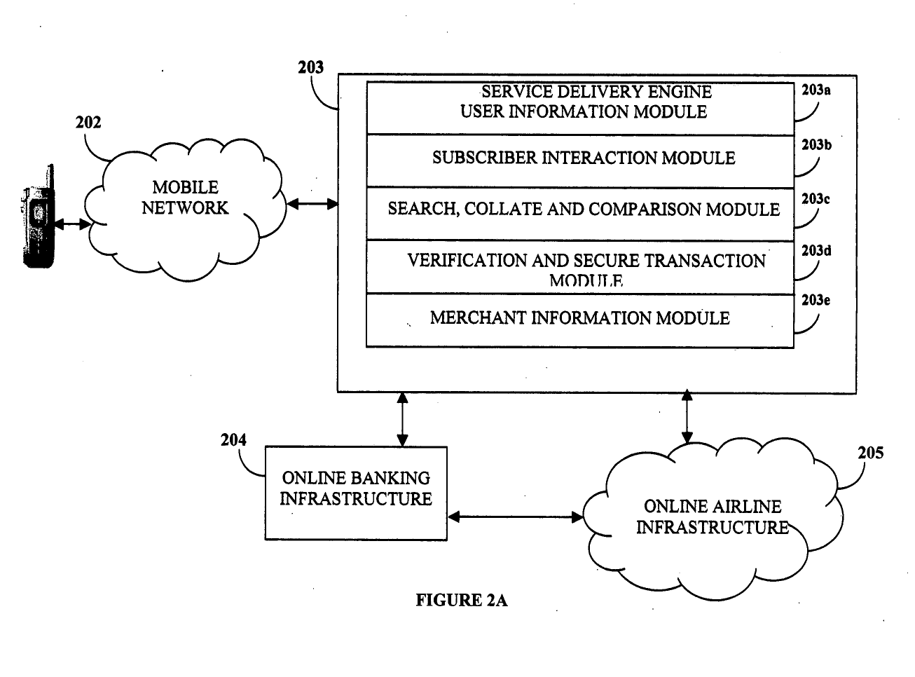

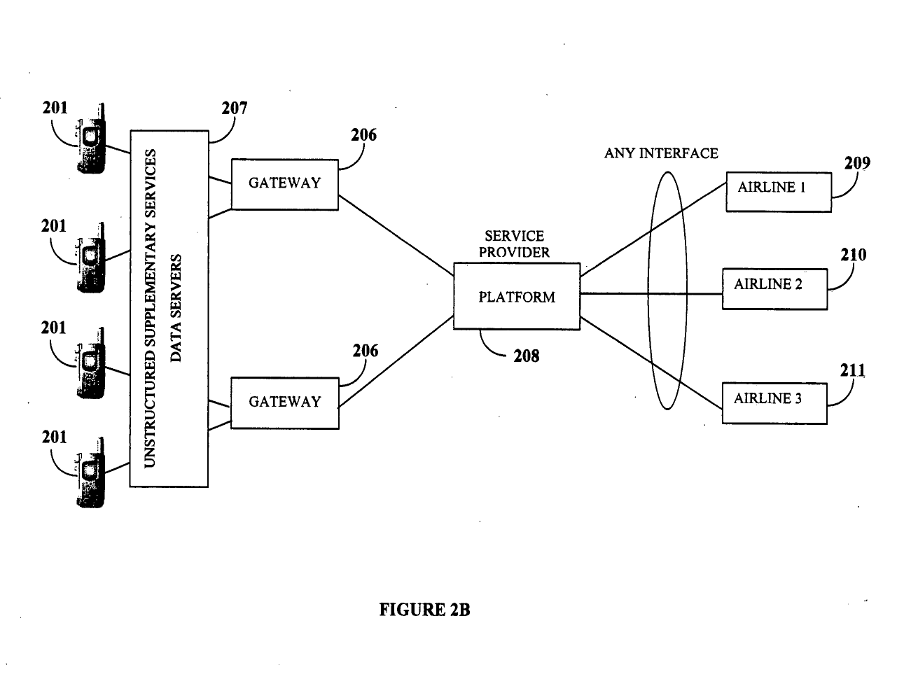

FIG. 2A illustrates a system for a subscriber to exchange information and transact with a plurality of airline companies for real time search, comparison and transaction activities over mobile networks. A subscriber accesses the online airline infrastructure 205 that is in communication with the mobile network 202 using a mobile handset 201. A service delivery engine 203 for interfacing the mobile network 202, online airline infrastructure 205 and online banking infrastructure 204. The service delivery engine 203 comprises a user information module 203a, subscriber interaction module 230b, search, collate and comparison module 203c, verification and secure transaction module 203d and merchant information module 203e. The user information module 203a stores data prior to transaction. The subscriber interaction module 203b communicates the subscriber's choice. The search, collate and comparison module 203c interfaces with plurality of said online airline infrastructures 205. The verification and secure transaction module 230d conducts verification and secure transactions on online banking infrastructure 204. The merchant information module 203e stores post transaction data.

The network infrastructure would be the backbone for interaction between the subscriber and the service delivery engine (SDE) 203. Upon stimulus from the subscriber, the service delivery infrastructure engine (SDIE) would then interface and/or transact with various and diverse entities including, but not limited to one or more of the following: banking servers, multiple merchants' online transaction infrastructure, customer support centers, etc.

The service delivery engine 203 residing on a designated server is collocated with a central server of the service provider of the mobile network 202. In another embodiment of the invention, the service delivery engine 203 is distributed in a plurality of servers on the mobile network 202.

The subscriber identity module in the mobile handset, which identifies each mobile handset in the mobile network, communicates with the mobile network 202 and prompts the subscriber to enter one or more passwords. The search, collate and comparison module 203c interacts with the airline companies online infrastructure 205 to query the plurality of airline companies based on the subscriber's choice and collate the results from the plurality of airline companies.

The verification and secure transaction module 203d gains access to the subscriber's account and queries the subscriber's bank infrastructure to check for a minimum required money balance.

In one embodiment of the invention, the online airline infrastructure 205 is an airline computer reservations system. Such an airline computer reservation system or global distribution system's primary function is to provide travel booking and travel related service facilities for travel agents. For example, the airline computer reservation system calculates prices of airline tickets. The information in the computer reservation system is fed by and used by used by one or more airlines.

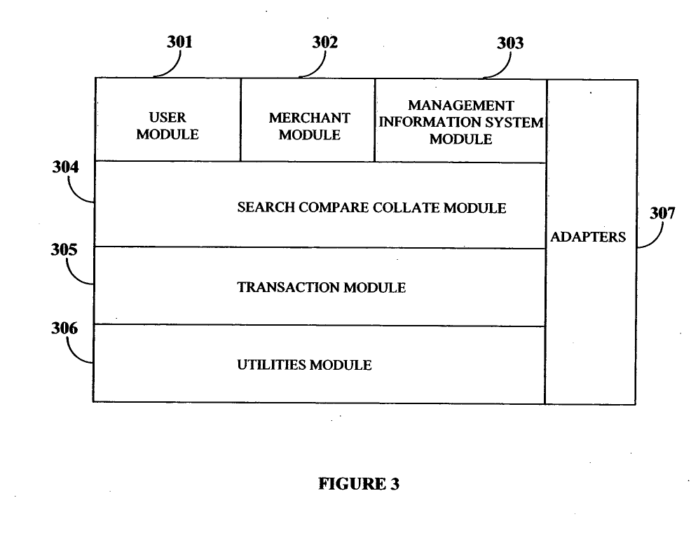

FIG. 2B illustrates a system for a subscriber to exchange information and transact with a plurality of airline companies for real time search, comparison and transaction activities over mobile networks. The system comprises of mobile handsets, gateways 206 i.e. Unstructured Supplementary Services Data USSD servers 207, the platform 208 of this invention as illustrated in FIG. 3 and airline online infrastructures. The mobile handsets communicate with the Gateways 206 over USSD 207. The gateways 206 interact with the Platform over Hyper Text Transfer Protocol Secure sockets/Internet Protocol HTTPS/IP. The platform interfaces with each of the airline servers 209, 210, and 211 over standard/proprietary protocols, as specified by the respective airline.

FIG. 3 illustrates the main components of a system that enables a subscriber to exchange information and transact with a plurality of airline companies for real time search, comparison and transaction activities over mobile networks. The user module 301 is the input and output interface for the end user. The merchant module 302 provides statistical information to airline companies. The management information system (MIS) module 303 is used for data mining the stored data. The MIS module 303 is accessed by the merchant module 302 and user module 301. The search compare collate module 304 interacts with the user module 301 and adapters 307 to provide the user with search results. The adapters 307 connect with the airline backend systems. The user may choose to exit or go ahead with the transaction. The transaction module 305 allows the user to conduct transactions, such as buying tickets. The utilities module 306 provides general wrapper services such as alerts, reimbursements, signing up new merchants, etc.

The apparatus and method of this invention is explained in light of the airline industry. However, the apparatus and method of this invention can also be applied to railroads, hotels, rental car companies, limousine companies, credit card companies, and travel agents.

1. A method for a subscriber to exchange information and transact with a plurality of airline companies for real time search, comparison and transaction activities over mobile networks connecting said subscriber's handset, online infrastructure of airline companies, a service delivery engine and online banking infrastructure, comprising the steps of:
providing a subscriber to view and choose among the menus and options for airline related transactions presented on said subscriber's handset;
communicating the subscriber's said choice among the menus and options to said service delivery engine via said mobile network;
querying the plurality of online infrastructures of airline companies based on the subscriber's choice, wherein said step of querying is performed by the service delivery engine and further comprises the steps of searching, collating and comparing from a plurality of online infrastructures of airline companies;
sending the results of said querying step to the subscriber's handset through the mobile network;
making a commercial transaction choice by the subscriber to avail a product or service corresponding to one of said sent results;
communicating the subscriber's chosen transaction choice to the service delivery engine via the mobile network; and
performing said chosen transaction at online infrastructure of the airline after conducting a successful verification operation by the service delivery engine in communication with the online banking infrastructure.

2. The method of claim 1, wherein the service delivery engine communicates with the mobile network and prompts the subscriber to enter one or more passwords to gain access to the subscriber's account on the online banking infrastructure.

3. The method of claim 1, wherein information comprising of details on fares, time of day, seat availability and flight number on said chosen transactions is stored in the service delivery engine.

4. The method of claim 3, wherein monthly reports and user statistics are generated from said stored information for extracting data on average selling price of tickets, pricing patterns on specific travel segments and pricing comparison among different airlines.

5. The method of claim 1, wherein the subscriber can regenerate lost tickets via input to said menu and options, update the online airline infrastructure with no show information, update the online airline infrastructure with late boarding information, or perform rebooking, cancellation and transfer operations using the menu and options.

6. The method of claim 1, wherein the information on said chosen transaction is communicated by the service delivery engine to the subscribers company, if the subscribers company has a pre-agreed arrangements with the online airline infrastructure.

7. A system for a subscriber to exchange information and transact with a plurality of airline companies for real time search, comparison and transaction activities, comprising the steps of:
a mobile network;
a subscriber handset for accessing said mobile network;
an online airline infrastructure in communication with the mobile network;
a service delivery engine for interfacing with said mobile network and online banking infrastructure, further comprising:
user information module for storing data prior to transaction;
subscriber interaction module for communicating the subscriber's choice;
search, collate and comparison module for interfacing with plurality of said online airline infrastructures;
verification and secure transaction module for online banking infrastructure transaction;
merchant information module for storing post transaction data;

8. The system of claim 8, wherein the service delivery engine distributed in a plurality of servers on the mobile network is collocated with a central server of the service provider of the mobile network.

9. The system claim of 8, wherein said search, collate and comparison module interacts with the airline companies online infrastructure to query the plurality of airline companies based on the subscriber's choice and collate the results from the plurality of airline companies.

10. The system of claim 8, wherein said verification and secure transaction module gains access to the subscriber's account and queries the subscriber's bank infrastructure to check for a minimum required money balance.
